(19) United States
(12) Patent Application Publication
(10) Pub. No.: US 2026/0016687 A1
(43) Pub. Date: Jan. 15, 2026

(54) ARRAY WAVEGUIDE SYSTEM AND AUGMENTED REALITY DISPLAY DEVICE

(71) Applicant: LINGXI-AR Technology Co., Ltd., Beijing (CN)

(72) Inventors: Zhiyuan GU, Beijing (CN); Yu ZHENG, Beijing (CN)

(21) Appl. No.: 19/264,927

(22) Filed: Jul. 10, 2025

(30) Foreign Application Priority Data
Jul. 12, 2024 (CN) 202410940147.2

(51) Int. Cl. G02B 27/00; G02B 27/01; G02B 27/10; G02B 27/14

(52) U.S. Cl. CPC G02B 27/0081; G02B 27/0172; G02B 27/1006; G02B 27/141; G02B 27/142; G02B 2027/0114; G02B 2027/0116

(57) ABSTRACT

Disclosed are an array waveguide system and an augmented reality display device. The system includes an optical engine, N two-dimensional array waveguide layers, and an adhesive layer. The optical engine is configured to emit image beams of N colors. The N two-dimensional array waveguide layers are sequentially stacked in order from near to far from the optical engine. An in-coupling portion is disposed in a light incident region of each two-dimensional array waveguide layer and adjacent to the optical engine. Each two-dimensional array waveguide layer includes a pupil expansion portion adjacent to the in-coupling portion. N≥2. The in-coupling portion at least includes a light incident surface, a reflection surface, and a light emission surface. The reflection surface is provided with a dichroic mirror.

### CROSS-REFERENCE TO RELATED APPLICATION(S)

This application claims priority to Chinese Patent Application No. 202410940147.2, filed on Jul. 12, 2024, the disclosure of which is incorporated herein by reference in its entirety.

### TECHNICAL FIELD

The present disclosure relates to the technical field of augmented reality and, in particular, to an array waveguide system and an augmented reality display device.

### BACKGROUND

The augmented reality (AR) technology, as a technology in which virtual information and the real world are ingeniously fused, is of great significance in fields such as military, industry, entertainment, medical treatment, and transportation. Main technologies currently used in transmissive head-mounted displays for augmented reality include Birdbath, prisms, free-form surfaces, and the optical waveguide technology. Compared with other technologies, a head-mounted display using the optical waveguide technology is smaller in size and more like a pair of glasses. The optical waveguide technology mainly includes array optical waveguides, surface relief grating waveguides, and volume holographic waveguides. Array optical waveguides are superior to diffractive optical waveguides and volume holographic waveguides in color performance and optical energy utilization. In particular, array optical waveguides using the two-dimensional exit pupil expansion technology have the advantages of a small in-coupling optical engine volume, a large exit pupil distance, and a large eye box.

Compared with diffractive optical waveguides, array optical waveguides utilize simple light reflection and refraction to implement the expansion of the exit pupil, thus resulting in better color uniformity and light efficiency performance. However, at present, the color uniformity of array waveguides on the market, especially two-dimensional array waveguides, still has a relatively large difference from the color performance of traditional displays. One of the important reasons is that the reflectivity of optical coatings varies with different light wavelengths.

In practice, after the image light projected by an optical engine enters an array waveguide through an in-coupling structure, the image light is transmitted to a light splitting surface after a certain length of transmission through total reflection. A part of the light is transmitted, and a part of the light is reflected. To implement this effect, an optical coating needs to be performed on the light splitting surface. As the optical coating utilizes the principle of light interference, the splitting ratio of the light at an optical interface is controlled by stacking dielectric layers with different thicknesses and made of different materials, thus implementing the desired effect. It is known according to the basic principle that under the condition of a certain layer structure, the splitting ratios of different wavelengths are different at the same incident angle and the splitting ratios of different incident angles are also different under the same wavelength.

In the array waveguide, in order to display a full-color image with a certain field of view (FOV), the light incident on the light splitting surface has a certain angle range and also a certain wavelength range. Therefore, when the splitting ratio of the light splitting surface varies with wavelength, a color variation may be caused in the final displayed image. Especially in a two-dimensional optical waveguide, the number of light splitting surfaces of a turning structure and the number of light splitting surfaces of an out-coupling structure are increased. Even if the splitting ratio of a light splitting surface varies slightly with wavelength, relatively serious color non-uniformity may still be caused. Therefore, in order to implement the color uniformity of the display image, coating is a huge challenge and also a problem that it is difficult to tackle in the existing two-dimensional array waveguides.

### SUMMARY

According to the problem in the related art, the present disclosure provides an array waveguide system and an augmented reality display device to solve the existing problem of color uniformity in a two-dimensional array waveguide system.

The technical solutions of the present disclosure are described below.

This specification provides an array waveguide system. The system includes an optical engine, N two-dimensional array waveguide layers, and an adhesive layer.

The optical engine is configured to emit image beams of N colors.

The N two-dimensional array waveguide layers are sequentially stacked in order from near to far from the optical engine. An in-coupling portion is disposed in a light incident region of each two-dimensional array waveguide layer of the N two-dimensional array waveguide layers and adjacent to the optical engine. The each two-dimensional array waveguide layer includes a pupil expansion portion adjacent to the in-coupling portion.

N≥2. The in-coupling portion at least includes a light incident surface, a reflection surface, and a light emission surface. The reflection surface is provided with a dichroic mirror. The pupil expansion portion includes a beam splitting film with a 50% splitting ratio embedded in the two-dimensional array waveguide layer at ½ of a thickness of the two-dimensional array waveguide layer. The beam splitting film with a 50% splitting ratio is parallel to a surface of the two-dimensional array waveguide layer.

The adhesive layer is disposed between adjacent two-dimensional array waveguide layers.

As a preferred technical solution, the each two-dimensional array waveguide layer includes a turning portion and an out-coupling portion that are embedded between a first substrate and a second substrate and are sequentially disposed in a first direction. The turning portion includes a plurality of first beam splitters equally spaced apart in a second direction at a first preset angle. The out-coupling portion includes a plurality of second beam splitters equally spaced apart in the first direction at a second preset angle. The N two-dimensional array waveguide layers have a same number of first beam splitters or different numbers of first beam splitters, a same first preset angle or different first preset angles; the N two-dimensional array waveguide layers have a same number of second beam splitters, and a same second preset angle. The first direction is perpendicular to the second direction.

As a preferred technical solution, the pupil expansion portion is located between the in-coupling portion and the turning portion. A length of the beam splitting film with a 50% splitting ratio in the two-dimensional array waveguide layer is five to six times a thickness of the two-dimensional array waveguide layer.

As a preferred technical solution, an included angle α is formed between the light incident surface and the reflection surface. The included angle α=30°-40°. The light emission surface is perpendicular to the light incident surface.

As a preferred technical solution, the in-coupling portion is a triangular prism. The included angle α=35°.

As a preferred technical solution, the N two-dimensional array waveguide layers have a same thickness or different thicknesses. The N two-dimensional array waveguide layers have a same refractive index or different refractive indexes.

As a preferred technical solution, the adhesive layer is a first optical adhesive layer; or the adhesive layer includes a first magnesium fluoride coating, a second optical adhesive layer, and a second magnesium fluoride coating. The second optical adhesive layer is located between the first magnesium fluoride coating and the second magnesium fluoride coating.

As a preferred technical solution, a thickness of the first optical adhesive layer is the same as or different from a thickness of the second optical adhesive layer. A thickness of the first magnesium fluoride coating is the same as or different from a thickness of the second magnesium fluoride coating.

As a preferred technical solution, each of the thickness of the first optical adhesive layer and the thickness of the second optical adhesive layer is 0.5-5 μm, and each of the thickness of the first magnesium fluoride coating and the thickness of the second magnesium fluoride coating is 80-500 nm.

This specification provides an augmented reality display device. The augmented reality display device includes the preceding array waveguide system.

The technical solutions used in the present disclosure achieve the beneficial effects described below.

This specification provides an array waveguide system and an augmented reality display device. The array waveguide system includes a plurality of two-dimensional array waveguide layers adhered into a whole. Each two-dimensional array waveguide layer includes an in-coupling portion and a pupil expansion portion. The in-coupling portion is provided with a dichroic mirror, and the pupil expansion portion is provided with a transflective film, implementing color separation transmission and display of different colors. Such an arrangement effectively balances overall colors, remarkably improving the color uniformity of the overall waveguide system and improving user experience. Moreover, the arrangement can effectively reduce the difficulty of the coating process, improving the mass productivity of waveguides.

### BRIEF DESCRIPTION OF DRAWINGS

To describe the technical solutions of embodiments of the present disclosure more clearly, drawings used in the description of the embodiments are briefly described below and form a part of the present disclosure. The example embodiments and descriptions thereof in the present disclosure explain the present disclosure and do not limit the present disclosure in any improper way. In the drawings:

FIG. 1 is a structural diagram of an array waveguide system according to this embodiment.

FIG. 2 is a structural diagram of the array waveguide system according to this embodiment.

FIG. 3 is a structural diagram of the array waveguide system according to this embodiment.

### REFERENCE LIST

100 array waveguide system
101 optical engine
102 in-coupling portion
103 pupil expansion portion
104 turning portion
105 out-coupling portion
110 first two-dimensional array waveguide layer
111 first in-coupling portion
112 first pupil expansion portion
113 first dichroic mirror
120 second two-dimensional array waveguide layer
121 second in-coupling portion
122 second pupil expansion portion
123 second dichroic mirror
130 adhesive layer

### DETAILED DESCRIPTION

To illustrate the object, technical solutions, and advantages of the present disclosure more clearly, the technical solutions of the present disclosure are described clearly and completely in conjunction with the embodiments of the present disclosure and the drawings. In the description of the present disclosure, it is to be noted that the term “or” is generally used in a meaning including “and/or” unless the content clearly indicates otherwise.

In the description of the present disclosure, it is to be understood that terms “first” and “second” are only configured to distinguish the description, and are not to be construed as indicating or implying relative importance. In the description of the present disclosure, it is to be noted that unless otherwise expressly specified and limited, the term “connected to each other” or “connected” should be construed in a broad sense, for example, as securely connected, detachably connected, or integrally connected; mechanically connected or electrically connected; directly connected to each other or indirectly connected to each other via an intermediary. For those of ordinary skill in the art, specific meanings of the preceding terms in the present disclosure may be understood based on specific situations.

Additionally, those skilled in the art should be understood that in the description of the present disclosure, orientational or positional relationships indicated by terms “longitudinal”, “transverse”, “above”, “below”, “front”, “back”, “left”, “right”, “vertical”, “horizontal”, “top”, “bottom”, “inside”, “outside” and the like are based on the orientational or positional relationships illustrated in the drawings, which are merely for facilitating and simplifying the description of the present disclosure. These relationships do not indicate or imply that an apparatus or component referred to have a specific orientation and is constructed and operated in a specific orientation, and thus it is not to be construed as limiting the present disclosure.

Apparently, the described embodiments are part, not all, of embodiments of the present disclosure. Based on the embodiments of the present disclosure, all other embodiments obtained by those of ordinary skill in the art without creative work are within the scope of the present disclosure.

### Embodiment

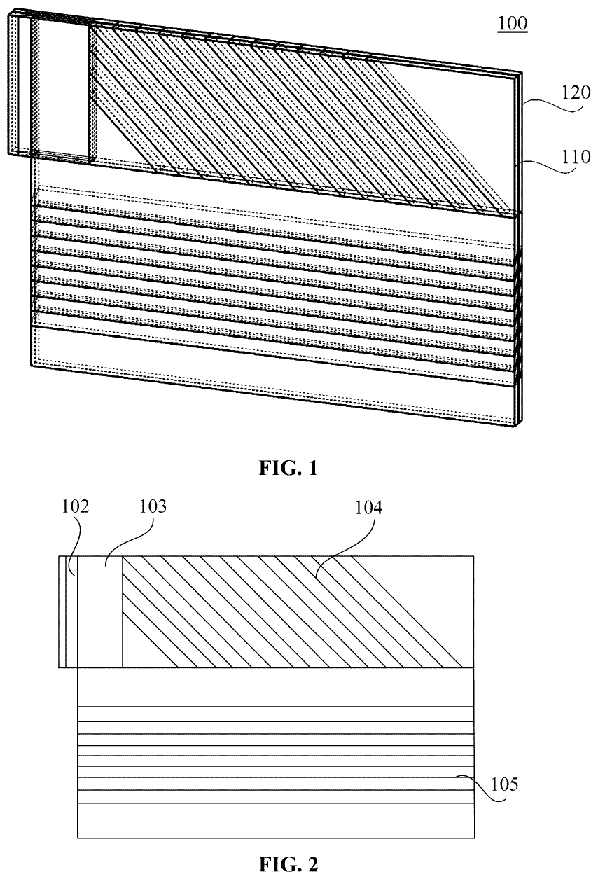

According to FIGS. 1 to 3, an array waveguide system 100 is included. The array waveguide system 100 includes an optical engine 101, N two-dimensional array waveguide layers, and an adhesive layer 130.

The optical engine 101 is configured to emit image beams of N colors. In this embodiment, it is not limited to the optical engine 101, but may also be a polychromatic laser or other manners capable of emitting polychromatic light sources, which is not specifically limited here.

The N two-dimensional array waveguide layers are sequentially stacked in order from near to far from the optical engine 101. An in-coupling portion 102 is disposed in a light incident region of each two-dimensional array waveguide layer and adjacent to the optical engine 101. The two-dimensional array waveguide layer includes a pupil expansion portion 103 adjacent to the in-coupling portion 102.

N≥2, and N is a positive integer. The in-coupling portion 102 includes at least a light incident surface, a reflection surface, and a light emission surface. The reflection surface is provided with a dichroic mirror. The pupil expansion portion 103 includes a beam splitting film with a 50% splitting ratio embedded in the two-dimensional array waveguide layer at ½ of the thickness of the two-dimensional array waveguide layer. The beam splitting film with a 50% splitting ratio is parallel to a surface of the two-dimensional array waveguide layer.

An adhesive layer 130 is disposed between adjacent two-dimensional array waveguide layers.

Based on the problem of color unevenness caused by the dispersion effect of an existing two-dimensional array waveguide, this embodiment provides an array waveguide system 100. The array waveguide system 100 includes a plurality of two-dimensional array waveguide layers adhered into a whole. Each two-dimensional array waveguide layer includes an in-coupling portion 102 and a pupil expansion portion 103. The in-coupling portion 102 is provided with a dichroic mirror, and the pupil expansion portion 103 is provided with a beam splitting film with a 50% splitting ratio, implementing color separation transmission and display of different colors. Such an arrangement effectively balances overall colors, remarkably improving the color uniformity of the overall waveguide system and improving user experience. Moreover, the arrangement can effectively reduce the difficulty of the coating process, improving the mass productivity of waveguides.

In one or more embodiments, the two-dimensional array waveguide layer includes a turning portion 104 and an out-coupling portion 105 that are embedded between a first substrate and a second substrate and are sequentially disposed in a first direction. The turning portion 104 includes a plurality of first beam splitters equally spaced apart in a second direction at a first preset angle. The out-coupling portion 105 includes a plurality of second beam splitters equally spaced apart in the first direction at a second preset angle. The two-dimensional array waveguide layers have the same number of first beam splitters or different numbers of first beam splitters, the same first preset angle or different first preset angles; the two-dimensional array waveguide layers have the same number of second beam splitters, and the same second preset angle. The first direction is perpendicular to the second direction.

In one or more embodiments, each two-dimensional array waveguide layer includes a first substrate, a second substrate, a turning portion 104, and an out-coupling portion 105. The turning portion 104 and the out-coupling portion 105 are embedded between the first substrate and the second substrate and are sequentially disposed in the first direction. The turning portion 104 includes a plurality of first beam splitters sequentially arranged in the second direction and arranged at a first preset angle with the second direction, so as to perform pupil expansion on the light entering the turning portion 104 in the second direction. After the turning, the light is incident to the out-coupling portion 105. The out-coupling portion 105 includes a plurality of second beam splitters sequentially arranged in the first direction and arranged at the second preset angle with the first direction. The multiple second beam splitters are parallel to the second direction and are configured to perform pupil expansion on the light output by the turning portion 104 and output the light to a human eye position in the first direction. The first preset angle is between 30° and 60° and is preferably 45°. The second preset angle is preferably 45°. The first direction is perpendicular to the second direction. In order to clarify directions, the second direction may also be set as an X-axis, and the first direction may be set as a Y-axis.

Further, the structures of the two-dimensional array waveguide layers may be the same or different. That is, the two-dimensional array waveguide layers are made of the same material or different materials. The first substrate and second substrate in the two-dimensional array waveguide layers are made of the same material and are preferably made of a glass material. The turning portions 104 in the two-dimensional array waveguide layer may be the same or different. Preferably, the turning portion 104 in each two-dimensional array waveguide layer is the same. For example, in each two-dimensional array waveguide layer, the turning portion 104 is made of glass, the first preset angle is the same, the number of first beam splitters is the same, the size of first beam splitters is the same, and the distance between first beam splitters is the same. The out-coupling portion 105 in each two-dimensional array waveguide layer may be the same. For example, in each two-dimensional array waveguide layer, the out-coupling portion 105 is made of glass, the second preset angle is the same, the number of second beam splitters is the same, the size of second beam splitters is the same, and the distance between second beam splitters is the same. The same structure of each two-dimensional array waveguide layer is better conductive to simplifying the processing difficulty in practice and saving costs.

In another embodiment, each two-dimensional array waveguide layer is made of the same material. The size of first beam splitters is the same. The distance between first beam splitters is the same. The size of second beam splitters is the same. The distance between second beam splitters is the same. That is, the size of first beam splitters in each layer is the same, and the size of second beam splitters in each layer is the same. That is, the distance between multiple first beam splitters is the same, the size of multiple second beam splitters is the same, the first preset angle is the same, and the second preset angle is the same. In this case, optical coatings embedded with first beam splitters and second beam splitters may be different, that is, may have different splitting ratios. For example, among multiple first beam splitters, the splitting ratio of the first first beam splitter is 90%, and the splitting ratio of the first first beam splitter in the next two-dimensional array waveguide layer is 80%, thereby adapting to actual color light conditions of different wavelengths, implementing color separation transmission and display of different colors, effectively balancing overall colors, and significantly improving the color uniformity of the overall waveguide system.

In one or more embodiments, the pupil expansion portion 103 is located between the in-coupling portion 102 and the turning portion 104. The length of the beam splitting film with a 50% splitting ratio is five to six times the thickness of the two-dimensional array waveguide layer.

In one or more embodiments, each two-dimensional array waveguide layer includes an in-coupling portion 102 disposed in a light incident region and an embedded pupil expansion portion 103. In actual operation, the coupling portion 102, the pupil expansion portion 103, the turning portion 104, and the out-coupling portion 105 may be all limited in the upper and lower substrates of the two-dimensional array waveguide layer, making the structure firmer and helping reduce process difficulty. The pupil expansion portion 103 is located between the in-coupling portion 102 and the turning portion 104. For example, the in-coupling portion 102, the pupil expansion portion 103, and the turning portion 104 are arranged sequentially in the second direction. Moreover, the pupil expansion portion 103 and the turning portion 104 are located at an upper portion of the two-dimensional array waveguide layer, and the out-coupling portion 105 is located at a lower portion of the two-dimensional array waveguide layer. The pupil expansion portion 103 is a beam splitting film with a 50% splitting ratio disposed inside the two-dimensional array waveguide layer and is preferably a transflective film. That is, the transflective film is disposed between the first substrate and the second substrate, is parallel to the first substrate and the second substrate, and is configured to perform pupil expansion on the light entering the pupil expansion portion 103 from the in-coupling portion 102 to fill the entrance pupil of a waveguide.

Further, referring to the front view in FIG. 2, the length of the pupil expansion portion 103 is five to six times the thickness of the two-dimensional array waveguide layer. For example, the polychromatic light emitted by the optical engine 101 enters the coupling portion 102 of the first two-dimensional array waveguide layer. The red light is reflected by a first dichroic mirror 113, and the other light is transmitted and enters the coupling portion 102 of the next two-dimensional array waveguide layer. The reflected red light is output after passing through a first pupil expansion portion 112, a first turning portion 104, and a first out-coupling portion 105 sequentially. In this case, the length of the first pupil expansion portion 112 is preferably five to six times the thickness of the first two-dimensional array waveguide layer, which is selected according to actual manufacturing needs of the two-dimensional array waveguide layer.

The thickness of the beam splitting film with a 50% splitting ratio differs by orders of magnitude from the thickness of the two-dimensional array waveguide layer, the first substrate, or the second substrate. Accordingly, the specific thickness may be set according to actual needs according to those skilled in the art as long as the light can penetrate the transflective film at least once in the pupil expansion portion 103 and can fill the entrance pupil of a waveguide.

In one or more embodiments, an included angle α is formed between the light incident surface and the reflection surface. The included angle α=30°-40°. The light emission surface is perpendicular to the light incident surface.

In one or more embodiments, the in-coupling portion is a triangular prism. The included angle α=35°.

In one or more embodiments, the coupling portion is preferably a triangular prism. The in-coupling portion 102 includes the light incident surface, the light emission surface, and the reflection surface. The reflection surface is provided with the dichroic mirror. The included angle α is formed between the light incident surface and the reflection surface. Preferably, the included angle α=35°. The light emission surface is perpendicular to the light incident surface and is disposed in the light incident region of the two-dimensional array waveguide layer. The in-coupling portion 102 is used in combination with the dichroic mirror to perform spectrum screening on multiple beams of incident light and couple the screened color light into a waveguide for propagation through total reflection.

In one or more embodiments, the two-dimensional array waveguide layers have a same thickness or different thickness. The two-dimensional array waveguide layers have a same refractive index or different refractive indexes.

In one or more embodiments, the thickness of each two-dimensional array waveguide layer may be selected by those skilled in the art according to actual needs and may be the same or different to adjust the brightness uniformity of different colors so as to improve the color brightness uniformity of the overall waveguide system, which is not specifically limited here.

In one or more embodiments, the adhesive layer 130 is a first optical adhesive layer. Alternatively, the adhesive layer 130 includes a first magnesium fluoride coating, a second optical adhesive layer, and a second magnesium fluoride coating. The second optical adhesive layer is located between the first magnesium fluoride coating and the second magnesium fluoride coating.

In one or more embodiments, the thickness of the first optical adhesive layer is the same as or different from the thickness of the second optical adhesive layer. The thickness of the first magnesium fluoride coating is the same as or different from the thickness of the second magnesium fluoride coating.

In one or more embodiments, each of the thickness of the first optical adhesive layer and the thickness of the second optical adhesive layer is 0.5-5 μm. Each of the thickness of the first magnesium fluoride coating and the thickness of the second magnesium fluoride coating is 80-500 nm.

In one or more embodiments, two types of adhesive layers 130 exist. An adhesive layer 130 of the first type is an optical adhesive layer. Two surfaces of an adhesive layer 130 of the second type are each provided with a magnesium fluoride coating. In practice, it may be that only adhesive layers 130 of the first type are disposed between multiple two-dimensional array waveguide layers; or, only adhesive layers 130 of the second type are disposed between the two-dimensional array waveguide layers; or, adhesive layers 130 of the first type and adhesive layers 130 of the second type are disposed alternately; or, adhesive layers 130 of the first type are disposed between one half of the two-dimensional array waveguide layers, and adhesive layers 130 of the second type are disposed between the other half of the two-dimensional array waveguide layers. The thickness of adhesive layers 130 may be different or the same. No matter which type of adhesive layers 130 is adopted, structural firmness is strengthened. The problem of light leakage crosstalk is avoided in the process of transverse light transmission, thereby improving brightness and uniformity and improving the efficiency of transmission through light total reflection.

In a preferred embodiment, the material and structure of each two-dimensional array waveguide layer are the same; that is, the refractive index is the same. In this case, a first optical adhesive layer is disposed between adjacent two-dimensional array waveguide layers. A first formula is satisfied as below.

$$sin ( 2 ω - \frac{μ}{2} ) \geq \frac{{n}_{G}}{{n}_{W}}$$

Alternatively, a second optical adhesive layer is disposed between adjacent two-dimensional array waveguide layers, and magnesium fluoride coatings are disposed on upper and lower surfaces of the second optical adhesive layer. That is, a first magnesium fluoride coating, the second optical adhesive layer, and a second magnesium fluoride coating are disposed; and the second optical adhesive layer is located between the first magnesium fluoride coating and the second magnesium fluoride coating. A second formula is satisfied as below.

$$sin ( 2 ω - \frac{μ}{2} ) \geq \frac{{n}_{C}}{{n}_{W}}$$

An ω angle is formed between a second beam splitter and the first direction. 0≤μ≤40°. The refractive index of each two-dimensional array waveguide layer is n_{W}. The refractive index of the first optical adhesive layer and the refractive index of the second optical adhesive layer are each n_{G}. The refractive index of the first magnesium fluoride coating and the refractive index of the second magnesium fluoride coating are each n_{C}.

In one or more embodiments, the thickness of an optical adhesive layer is 0.5-5 μm. The thickness of each magnesium fluoride coating is 80-500 nm. A specific thickness is set according to actual needs. In actual operation, magnesium fluoride coatings may be first coated on opposite surfaces of the adjacent two-dimensional array waveguide layers, and the second optical adhesive layer is disposed between the first magnesium fluoride coating and the second magnesium fluoride coating. In this case, the adhering of the adjacent two-dimensional array waveguide layers is completed and may be completed by manual adhering or through an adhering device. The specific adhering process and device may be selected according to actual needs as long as the purpose of accurate adhering is implemented.

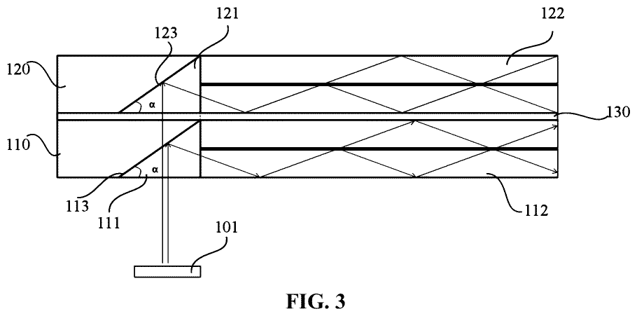

FIG. 3 shows an optical path diagram after the light of the optical engine 101 enters a waveguide. The first substrate and the second substrate in each two-dimensional array waveguide layer are parallel to each other. In this embodiment, an example in which N=2 is used for description. The optical engine 101 emits a full-color image of red light and blue-green light. A first two-dimensional array waveguide layer 110 and a second two-dimensional array waveguide layer 120 have the same structure and are made of the same material. In-coupling portions 102 and pupil expansion portions 103 have the same structure and are made of the same material which is glass for description. Each in-coupling portion 102 is a triangular prism. Each included angle α=35°. The first two-dimensional array waveguide layer 110 and the second two-dimensional array waveguide layer 120 are sequentially stacked in order from near to far from the optical engine 101. The light from a turning portion 104 to an out-coupling portion 105 and output to the human eye is the same as that in a traditional two-dimensional waveguide optical path, which is thereby not repeated here. In this embodiment, the optical path in which light is emitted from the optical engine 101 to an out-coupling portion 102 and then to a pupil expansion portion 103 is introduced.

The full-color image projected from the optical engine 101 is transmitted through a first light incident surface, enters a first in-coupling portion 111, and is incident on the first dichroic mirror 113 so that the first dichroic mirror 113 performs 100% reflection on the red light in the full-color image, with the wavelength range thereof between 600 nm and 640 nm. The specific range is determined according to the wavelengths of all LEDs in the optical engine 101. Moreover, the blue-green light is transmitted 100%, with the wavelength range thereof between 450 nm and 540 nm. The specific range is determined according to the wavelengths of all LEDs in an optical engine. Due to the placement angle α of the dichroic mirror and the existence of an adhesive layer 130, the reflected red light is limited in the first two-dimensional array waveguide layer 110 to be propagated through total reflection. When the light encounters a beam splitting film with a 50% splitting ratio each time, sub-light is split to fill the entrance pupil of the first two-dimensional array waveguide layer 110. The red light filling the first two-dimensional array waveguide layer 110 is transmitted through total reflection in the first two-dimensional array waveguide layer 110 all the time, is coupled out sequentially through the first turning portion 104 and the first out-coupling portion 105, and is then incident to the human eye.

Similarly, the blue-green light transmitted through the first in-coupling portion 111 enters a second in-coupling portion 121 through a second light incident surface and is incident on a second dichroic mirror 123. The second dichroic mirror 123 performs 100% reflection on the blue-green light in the full-color image, with the wavelength range between 450 nm and 540 nm. The specific range is determined according to the wavelengths of all LEDs in the optical engine. Similar to the red light, after passing through a second pupil expansion portion 122, the blue-green light also fills the entrance pupil of the second two-dimensional array waveguide layer 120, is coupled out sequentially through a second turning portion 104 and the second out-coupling portion 105, and is then incident to the human eye. Finally, the human eye receives the complete, full-color image.

In this process, the first turning portion 104 in the first two-dimensional array waveguide layer 110 and the first out-coupling portion 105 in the first two-dimensional array waveguide layer 110 only need to perform coating design and processing on the red light. Compared with the previous full-color coating design, in this solution, the wavelength range is greatly reduced, greatly reducing coating difficulty and improving coating effect and mass productivity. Similarly, the wavelength range of the blue-green light is much smaller than the wavelength range of the whole waveguide, thus greatly reducing coating difficulty and greatly improving coating effect and mass productivity. Additionally, the design of the adhesive layer 130 enhances structural firmness and improves brightness and uniformity.

The solution in this embodiment may also be suitable for designing multiple two-dimensional array waveguide layers. For example, two two-dimensional array waveguide layers are provided and are designed for red light and blue-green light to correspond to red light transmission and blue-green light transmission respectively. Besides, three two-dimensional array waveguide layers may also be provided and are designed for red light, blue light, and green light to correspond to red light transmission, green light transmission, and blue light transmission respectively. Therefore, the color uniformity of the waveguide is effectively improved, coating difficulty is reduced, and the mass productivity of waveguides is improved.

This embodiment further provides an augmented reality display device. The augmented reality display device includes the preceding array waveguide system 100, effectively implementing color separation transmission and display of different colors, significantly improving the color uniformity of the overall waveguide system, improving user experience, effectively reducing the difficulty of the coating process, and improving the mass productivity of waveguides.

The array waveguide system and the augmented reality display device in embodiments of the present application are described above in detail. The principles and implementations of the present application are described herein with specific examples. The preceding description of the preceding embodiments is only for assisting in understanding the method of the present application and the core ideas thereof. Moreover, for those of ordinary skill in the art, according to the idea of the present application, there will be changes in specific implementations and applications. In summary, the content of this specification should not be construed as limiting the present application.

What is claimed is:

1. An array waveguide system, comprising:
an optical engine configured to emit image beams of N colors;
N two-dimensional array waveguide layers, wherein the N two-dimensional array waveguide layers are sequentially stacked in order from near to far from the optical engine, an in-coupling portion is disposed in a light incident region of a two-dimensional array waveguide layer of the N two-dimensional array waveguide layers and adjacent to the optical engine, and the two-dimensional array waveguide layer comprises a pupil expansion portion adjacent to the in-coupling portion, wherein N≥2;
the in-coupling portion at least comprises a light incident surface, a reflection surface, and a light emission surface; the reflection surface is provided with a dichroic mirror; the pupil expansion portion comprises a beam splitting film with a 50% splitting ratio embedded in the two-dimensional array waveguide layer at ½ of a thickness of the two-dimensional array waveguide layer; and the beam splitting film with a 50% splitting ratio is parallel to a surface of the two-dimensional array waveguide layer; and
an adhesive layer, wherein the adhesive layer is disposed between adjacent two-dimensional array waveguide layers of the N two-dimensional array waveguide layers.

2. The array waveguide system according to claim 1, wherein the two-dimensional array waveguide layer comprises a turning portion and an out-coupling portion that are embedded between a first substrate and a second substrate and are sequentially disposed in a first direction, the turning portion comprises a plurality of first beam splitters equally spaced apart in a second direction at a first preset angle, and the out-coupling portion comprises a plurality of second beam splitters equally spaced apart in the first direction at a second preset angle, wherein the N two-dimensional array waveguide layers have a same number of first beam splitters or different numbers of first beam splitters, a same first preset angle or different first preset angles; and the N two-dimensional array waveguide layers have a same number of second beam splitters, and a same second preset angle, and the first direction is perpendicular to the second direction.

3. The array waveguide system according to claim 2, wherein the pupil expansion portion is located between the in-coupling portion and the turning portion, and a length of the beam splitting film with a 50% splitting ratio in the two-dimensional array waveguide layer is five to six times a thickness of the two-dimensional array waveguide layer corresponding to the beam splitting film with a 50% splitting ratio.

4. The array waveguide system according to claim 3, wherein an included angle α is formed between the light incident surface and the reflection surface, the included angle α=30°-40°, and the light emission surface is perpendicular to the light incident surface.

5. The array waveguide system according to claim 4, wherein the in-coupling portion is a triangular prism, and the included angle α=35°.

6. The array waveguide system according to claim 1, wherein the N two-dimensional array waveguide layers have a same thickness or different thicknesses, and the N two-dimensional array waveguide layers have a same refractive index or different refractive indexes.

7. The array waveguide system according to claim 1, wherein the adhesive layer is a first optical adhesive layer, or the adhesive layer comprises a first magnesium fluoride coating, a second optical adhesive layer, and a second magnesium fluoride coating; wherein the second optical adhesive layer is located between the first magnesium fluoride coating and the second magnesium fluoride coating.

8. The array waveguide system according to claim 2, wherein the adhesive layer is a first optical adhesive layer, or the adhesive layer comprises a first magnesium fluoride coating, a second optical adhesive layer, and a second magnesium fluoride coating; wherein the second optical adhesive layer is located between the first magnesium fluoride coating and the second magnesium fluoride coating.

9. The array waveguide system according to claim 3, wherein the adhesive layer is a first optical adhesive layer, or the adhesive layer comprises a first magnesium fluoride coating, a second optical adhesive layer, and a second magnesium fluoride coating; wherein the second optical adhesive layer is located between the first magnesium fluoride coating and the second magnesium fluoride coating.

10. The array waveguide system according to claim 4, wherein the adhesive layer is a first optical adhesive layer, or the adhesive layer comprises a first magnesium fluoride coating, a second optical adhesive layer, and a second magnesium fluoride coating; wherein the second optical adhesive layer is located between the first magnesium fluoride coating and the second magnesium fluoride coating.

11. The array waveguide system according to claim 5, wherein the adhesive layer is a first optical adhesive layer, or the adhesive layer comprises a first magnesium fluoride coating, a second optical adhesive layer, and a second magnesium fluoride coating; wherein the second optical adhesive layer is located between the first magnesium fluoride coating and the second magnesium fluoride coating.

12. The array waveguide system according to claim 6, wherein the adhesive layer is a first optical adhesive layer, or the adhesive layer comprises a first magnesium fluoride coating, a second optical adhesive layer, and a second magnesium fluoride coating; wherein the second optical adhesive layer is located between the first magnesium fluoride coating and the second magnesium fluoride coating.

13. The array waveguide system according to claim 7, wherein a thickness of the first optical adhesive layer is the same as or different from a thickness of the second optical adhesive layer, and a thickness of the first magnesium fluoride coating is the same as or different from a thickness of the second magnesium fluoride coating.

14. The array waveguide system according to claim 13, wherein each of the thickness of the first optical adhesive layer and the thickness of the second optical adhesive layer is 0.5-5 μm, and each of the thickness of the first magnesium fluoride coating and the thickness of the second magnesium fluoride coating is 80-500 nm.

15. An augmented reality display device, comprising an array waveguide system, wherein the array waveguide system comprises:
an optical engine configured to emit image beams of N colors;
N two-dimensional array waveguide layers, wherein the N two-dimensional array waveguide layers are sequentially stacked in order from near to far from the optical engine, an in-coupling portion is disposed in a light incident region of a two-dimensional array waveguide layer of the N two-dimensional array waveguide layers and adjacent to the optical engine, and the two-dimensional array waveguide layer comprises a pupil expansion portion adjacent to the in-coupling portion, wherein
N≥2; the in-coupling portion at least comprises a light incident surface, a reflection surface, and a light emission surface; the reflection surface is provided with a dichroic mirror; the pupil expansion portion comprises a beam splitting film with a 50% splitting ratio embedded in the two-dimensional array waveguide layer at ½ of a thickness of the two-dimensional array waveguide layer; and the beam splitting film with a 50% splitting ratio is parallel to a surface of the two-dimensional array waveguide layer; and
an adhesive layer, wherein the adhesive layer is disposed between adjacent two-dimensional array waveguide layers of the N two-dimensional array waveguide layers.

16. The augmented reality display device according to claim 15, wherein the two-dimensional array waveguide layer comprises a turning portion and an out-coupling portion that are embedded between a first substrate and a second substrate and are sequentially disposed in a first direction, the turning portion comprises a plurality of first beam splitters equally spaced apart in a second direction at a first preset angle, and the out-coupling portion comprises a plurality of second beam splitters equally spaced apart in the first direction at a second preset angle, wherein the N two-dimensional array waveguide layers have a same number of first beam splitters or different numbers of first beam splitters, a same first preset angle or different first preset angles; and the N two-dimensional array waveguide layers have a same number of second beam splitters, and a same second preset angle, and the first direction is perpendicular to the second direction.

17. The augmented reality display device according to claim 16, wherein the pupil expansion portion is located between the in-coupling portion and the turning portion, and a length of the beam splitting film with a 50% splitting ratio in the two-dimensional array waveguide layer is five to six times a thickness of the two-dimensional array waveguide layer corresponding to the beam splitting film with a 50% splitting ratio.

18. The augmented reality display device according to claim 17, wherein an included angle α is formed between the light incident surface and the reflection surface, the included angle α=30°-40°, and the light emission surface is perpendicular to the light incident surface.

19. The augmented reality display device according to claim 18, wherein the in-coupling portion is a triangular prism, and the included angle α=35°.

20. The augmented reality display device according to claim 15, wherein the N two-dimensional array waveguide layers have a same thickness or different thicknesses, and the N two-dimensional array waveguide layers have a same refractive index or different refractive indexes.
